(19) United States
(12) Patent Application Publication
(10) Pub. No.: US 2022/0258448 A1
(43) Pub. Date: Aug. 18, 2022

(54) Foldable Three Layers Chair Mat

(71) Applicant: Chunlian Yu, Quzhou (CN)

(72) Inventor: Chunlian Yu, Quzhou (CN)

(21) Appl. No.: 17/489,997

(22) Filed: Sep. 30, 2021

Related U.S. Application Data
(60) Provisional application No. 63/149,443, filed on Feb. 15, 2021.

(51) Int. Cl. B32B 3/18; B32B 7/12; B32B 5/02; B32B 27/12; B32B 21/10

(52) U.S. Cl. CPC B32B 3/18; B32B 7/12; B32B 5/024; B32B 2307/744; B32B 27/12; B32B 21/10; B32B 5/026

(57) ABSTRACT

Present invention discloses a foldable three layers chair mat comprising an upper surface rug layer made by woven or knitted rug, allow chair wheels roll on it smoothly; a middle layer made by rigid material seamlessly spliced together by more then two parts, wherein the rigid layers are glued and holded by the rug layer as a hinge, allow to fold; and a lower surface anti-skip layer be glued on the lower surface of the rigid layer. The mat has a hard texture but a smooth surface. It can be used not only on hard floors such as wooden floors but also on soft carpets. Its surface is covered with soft and beautiful cloth, which is durable and beautiful. The special is that the folds are seamlessly spliced together, and the chair wheels can roll on without any obstacles.

### CROSS-REFERENCE TO RELATED APPLICATION

This disclosure claims the benefit of the priority of U.S. Provisional Patent Application No. 63/149,443, entitled “A Foldable Three Layers Chair Mat” filed on Feb. 15, 2021. The above-identified application is incorporated herein by reference in its entirety.

### FIELD OF INVENTION

The present invention relates to a foldable mat and more particularly a foldable three layers chair mat.

### BACKGROUND OF INVENTION

Our office and home floors are always wooden or carpeted, and our favorite office chairs often have wheels. In daily use, the wheels will wear our wooden floor, or it cannot roll on the carpet.

In response to the above problems, a variety of chair mats have emerged in recent years, such as PVC chair mat, wooden chair mat, and even-tempered glass chair mat. However, none of these chair mats can perfectly solve the problem. For example, PVC chair mat is often easy to curl and deform, and the chair wheels are not easy to roll on it. There is always a large gap in the folding of the wooden chair mat causes the wheels to roll unsmoothly, and the cost is too high. Although the tempered glass chair mat is smooth, it is too heavy and easy to break and hurt people.

Present invention is a foldable chair mat with a hard texture but a smooth surface. It can be used not only on hard floors such as wooden floors but also on soft carpets. Its surface is covered with soft and beautiful cloth, which is durable and beautiful. The special is that the folds are seamlessly spliced together, and the chair wheels can roll on without any obstacles.

### SUMMARY OF THE INVENTION

The present invention is in a foldable three layers chair mat that has a upper surface made by woven or knitted rug, middle layer made by rigid material such as plastic or wood, lower surface made by anti-skip felt. The two middle rigid layers are placed tightly together. The upper surface is glued to the two middle rigid layers, and holds the two middle rigid layers seamlessly spliced together to allow wheel chair roll on the upper surface smoothly.

### BRIEF DESCRIPTION OF THE DRAWINGS

FIG. 1 is a sectional view of the chair mat.

FIG. 2 is a perspective of the chair mat.

FIG. 3 is a perspective of the chair mat in folding state.

FIG. 4 is a top view of the chair mat laid open and flat.

FIG. 5 is a bottom view of the chair mat laid open and flat.

FIG. 6 is an expended view of the chair mat upper surface rug layer made by woven or carpet.

FIG. 7 is a plan view of the chair mat 2 middle rigid layers forming one integral whole layer.

FIG. 8 is a bottom view of the 2 middle rigid layers laid over and glued to the upper surface rug layer. The 2 rigid layer should be seamlessly spliced together.

FIG. 9 is a bottom view of the upper surface rug layer fold and wrap the 2 middle rigid layer and glue together.

FIG. 10 is a bottom plan view of the non-skid layer laid over the 2 middle rigid layer and glued together.

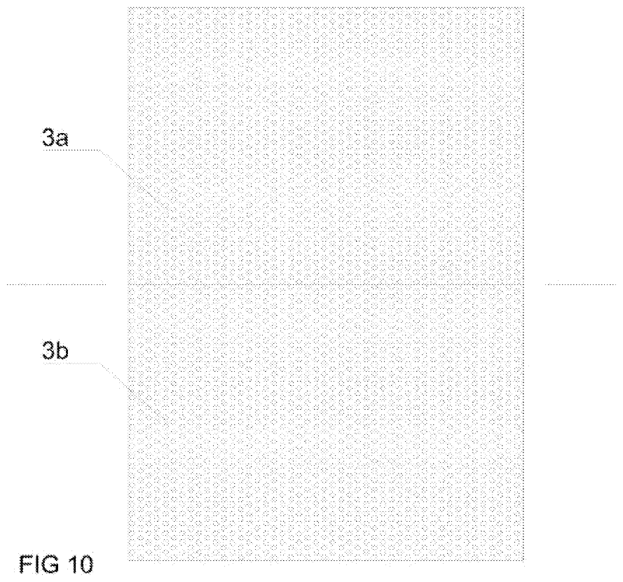

### DETAILED DESCRIPTION OF INVENTION

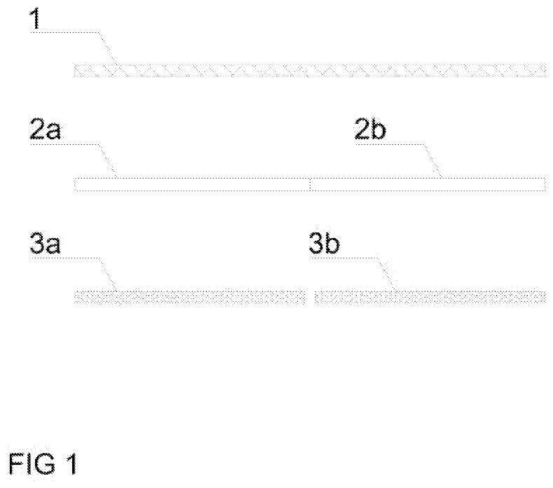

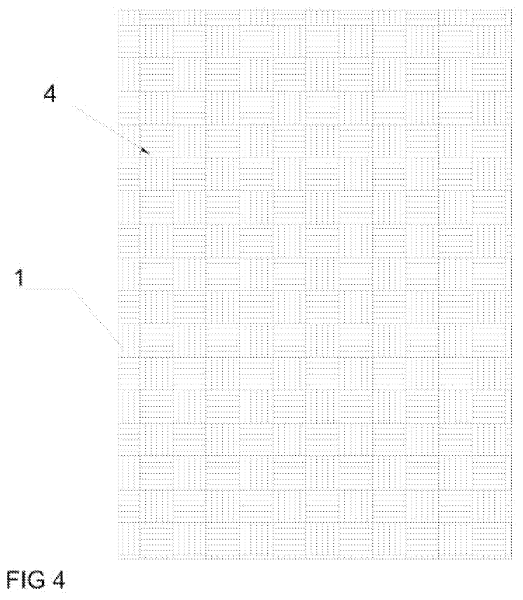

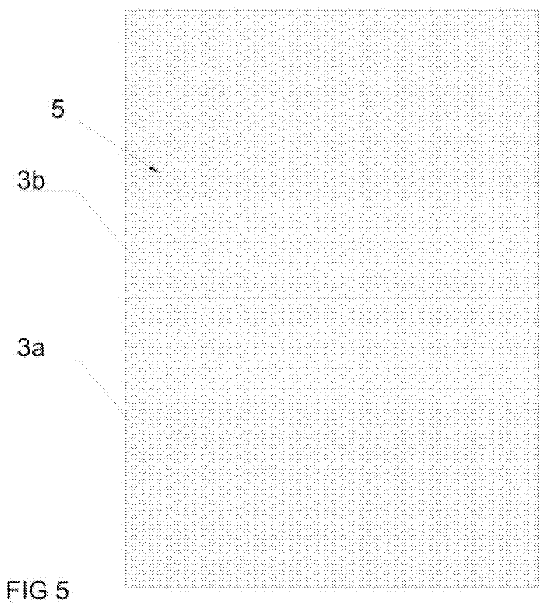

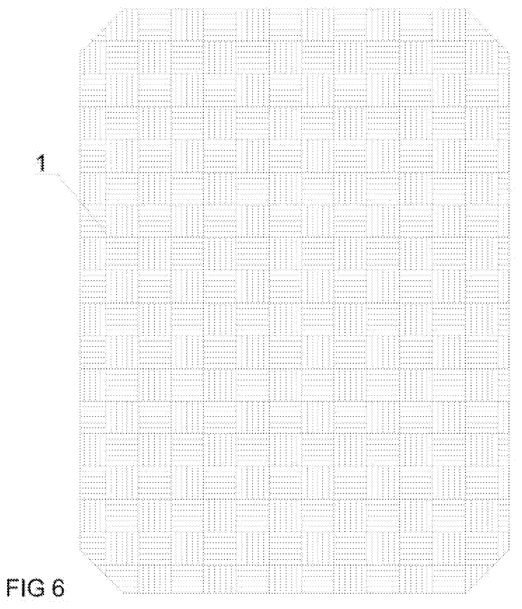

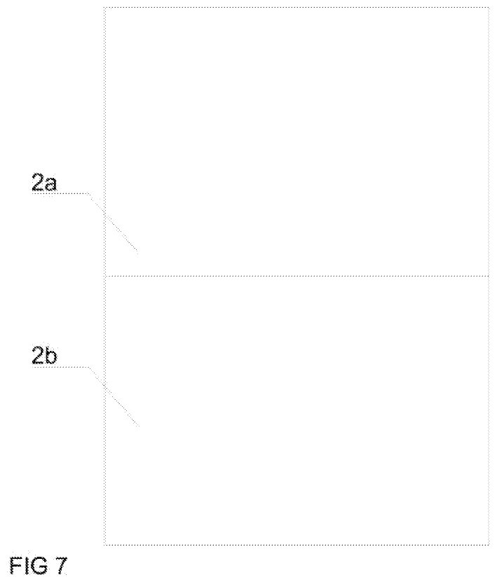

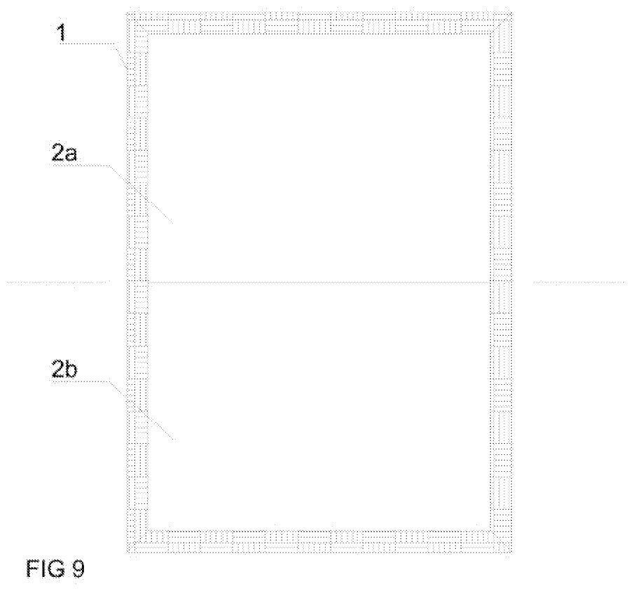

Referring now to FIG. 1, the chair mat has a three-layer structure. The first rug layer 1 (show in FIG. 4 or FIG. 6) is made of fabric such as cloth or leather, and the second layers 2a and 2b are rigid layers, which can be made of wood or plastic boards. It will be understood that, the second rigid layer can also be divided into 3 or more parts. The third layer 3 is a non-slip layer separate into 2 parts 3a and 3b (show in FIG. 5), made of rubber or plastic felt cloth. It is directly glued on the bottom surface of the rigid layer 2a and 2b with glue, and the chair mat can be firmly attached to the ground without moving. The special feature of the structure is that the two rigid layer 2a and 2b must be seamlessly spliced together (show in FIG. 7), and glued and wrap by the first rug layer 1 (show in FIG. 9), so that when unfolding the chair mat, it allows the chair wheel smooth rolling on the rug layer 1 without any obstacles.

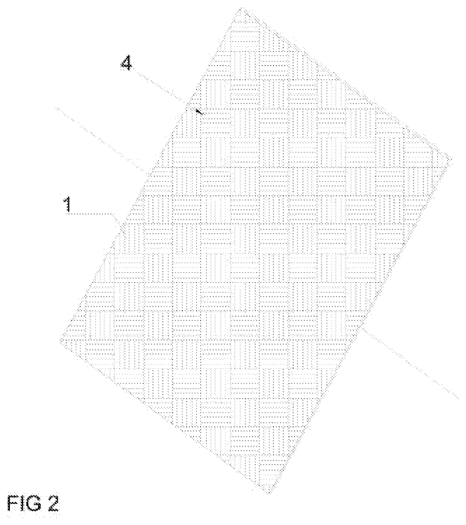

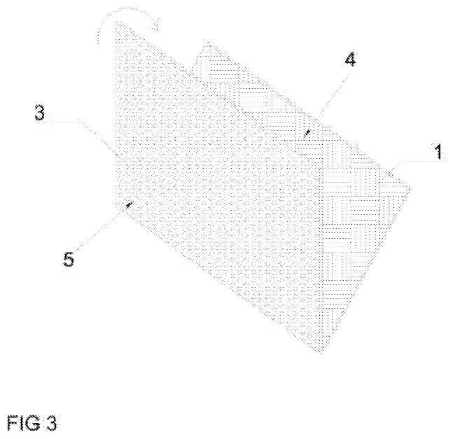

Referring now to FIG. 2-3 is how to use the chair mat. FIG. 2 is a perspective of the chair mat unfold state. The upper surface 4 is rug layer can have various designs to make the chair mat looks like a practical artwork. The upper surface 4 allows the chair wheel rolling on it from one place to another. FIG. 3 is a perspective of the chair mat in folding state. The special structure is that the upper surface 4 of the chair mat (rug layer 1) is close together when folded, and the lower surface 5 (the anti-slip layer 3) of the chair mat is exposed to the outside. Because the two rigid layers 2a and 2b of the chair mat are seamlessly spliced together (as shown in FIG. 7) and tightly glued together by the rug layer 1, only in this way the seams be avoided when the chair mat is unfolded, allows the chair wheel smooth rolling on the rug layer 1 without any obstacles. Therefore, an important feature of the chair mat is that the upper surface 4 is close together when folded.

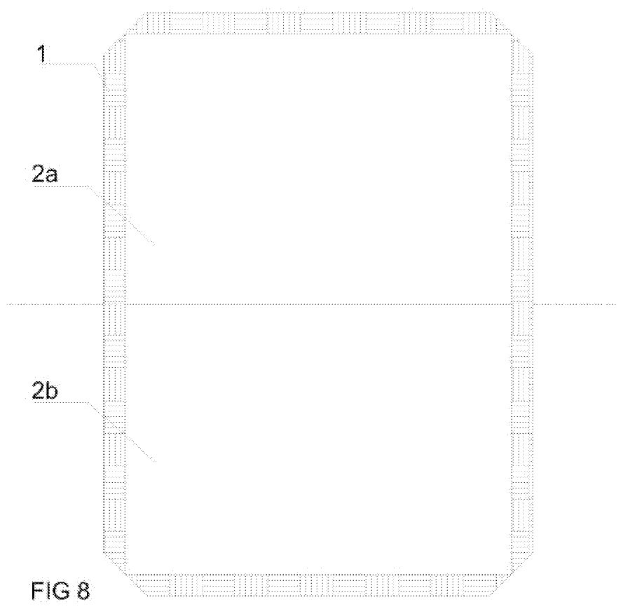

As shown in FIG. 4 is a top view of the chair mat laid open and flat. The first rug layer 1 of the chair mat completely covers the upper surface of the rigid layer 2, as shown in FIG. 8, the area of the rug layer 1 is larger than the area of the rigid layer 2, and extends to the lower surface of the rigid layer 2 (shown in FIG. 9). The rug layer 1 has 4 chamfers, which allow to the rug layer 1 wrap to the lower surface of the rigid layer 2 exactly.

FIG. 5 is a bottom view of the chair mat laid open and flat. It can be seen that the anti-slip layer 3 is separated into 2 parts 3a and 3b. The material can be rubber or plastic felt cloth. The non-slip layer 3 is glued on the lower surface of the rigid layer 2 trimly.

Referring now to FIG. 7 the rigid layer 2 consists of two parts 2a and 2b, it is conceivable that there can be 3 or more parts. The characteristic is that they must be tightly and seamlessly spliced together. Ensure the wheels to roll smoothly without obstacles when unfolded. The rigid layer 2 can be made of hard plastic, wood board and other materials, with a thickness of more than 1 mm.

The following describes the assembly steps of the chair cushion. First, as shown in FIG. 7 secure the two rigid layers 2a and 2b seamlessly spliced together with a fixture (not show), and apply glue evenly to the rigid layers 2a and 2b. Then cover the rug layer 1 shipshape on the rigid layers 2a and 2b, as shown in FIG. 6. Wait until the glue to dry and fix, remove the rigid layers 2a and 2b out from the fixture, the rug layer 1 and rigid layer 2 has became a whole part together. Then flip the direction as shown in FIG. 8, the lower surfaces of rigid layers 2a and 2b turn upwards. Apply glue to the edges of the rigid layer 2, and wrap the extended rug layer 1 to the edges of the rigid layers 2a and 2b as shown in FIG. 9. Finally, apply glue on the lower surface of the rigid layers 2a and 2b and the extended part of the rug layer 1, and cover the non-slip layers 3a and 3b trimly. Wait for the glue to dry before folding and packaging.

As various changes could be made in the above products and methods without departing from the scope of the invention, it is intended that all matter contained in the above description shall be interpreted as illustrative and not in a limiting sense.

What is claimed is:

1. A foldable three layers chair mat comprising:
an upper surface rug layer made by woven or knitted rug, allows chair wheels roll on it smoothly;
a middle layer made by rigid material seamlessly spliced together by two or more parts, wherein the rigid layer is glued and holded by the rug layer as a hinge, allows to fold; and
a lower surface anti-skip layer be glued on the lower surface of the rigid layer, wherein the folding structure is that the upper surface rug layer of the chair mat is close together when folded, and the lower surface anti-slip layer of the chair mat is exposed to the outside when folded.

2. The foldable three layers chair mat as claimed in claim 1, wherein the middle rigid layer is seamlessly spliced together glued by rug layer, so that the upper surface has no seams or hollow to allow wheel chair roll on the upper surface smoothly.
